(19) United States
(12) Patent Application Publication
(10) Pub. No.: US 2014/0370231 A1
(43) Pub. Date: Dec. 18, 2014

(54) Laminar Building Block, and System and Method for its Manufacture

(71) Applicant: Dirk Wallace, West Linn, OR (US)

(72) Inventor: Dirk Wallace, West Linn, OR (US)

(21) Appl. No.: 13/916,711

(22) Filed: Jun. 13, 2013

(51) Int. Cl. B32B 21/14; B27D 1/08; B32B 37/02

(52) U.S. Cl. CPC B32B 21/14; B32B 37/02; B27D 1/08; B32B 2317/16; B32B 2479/00; B32B 2451/00
USPC 428/109; 156/182; 428/114; 428/107

(57) ABSTRACT

A laminar sheet and building block include re-sawed mini-sheets from laminar plank or beam starting material wherein the mini-sheets are oriented transversely to one another and vertically stacked and adhered. A system and methods for their manufacture also are also disclosed. The building block features a unique surface and edge appearance and is denser, more durable, more sag- and warp-resistant, and less expensive than conventional building blocks.

### RELATED APPLICATIONS

This application claims the benefit of priority to U.S. Provisional Application No. 61/659,234 entitled LAMINAR BUILDING BLOCK, AND SYSTEM AND METHOD FOR ITS MANUFACTURE, filed on Jun. 13, 2012, the contents of which are hereby incorporated in their entirety by this reference.

### FIELD OF THE INVENTION

The invention relates generally to the field of building blocks for cabinet, table, counter top, furniture, or other manufacture. More particularly, the invention relates to a novel laminar building block and a system and method for its manufacture.

### BACKGROUND OF THE INVENTION

Plywood is the conventional laminar building block for cabinet and furniture manufacture. It includes generally planar wood expanses of thin planar laminates vertically stacked and adhered to one another into large planar sheets of a given thickness. Plywood typically includes plural, vertically stacked, thin, planar plies of fir or the like adhered such that adjacent pairs of plies are oriented with their grains perpendicular to one another.

Recent advances in laminar building blocks include the use of a wider variety of materials for the various adhered plies in the construction of the large planar sheets. Such materials include individual strips or strands of bamboo and even coconut shells. PLYBOO™, for example, makes its sheets out of individual thin strands of bamboo laid side-by-side and adhered to form a thin planar ply that is then laminated with like plies to form sheets. KIRIE™, for another example, makes its sheets out of individual thin strands of coconut shell laid side-by-side and adhered to form a thin planar ply that is then laminated with like plies to form sheets. Such a process of laying individual thin strands of material side-by-side to produce thin planar plies suitable for vertical stacking to form sheets is labor intensive and thus expensive. Moreover, such a process requires a lot of filler to fill voids that are created when individual reeds or strands of various densities, shapes, and sizes are laid side by side and pressed and adhered to form the thin planar ply.

### BRIEF DESCRIPTION OF THE DRAWINGS

FIGS. 1A and 1B, and FIGS. 2A and 2B illustrate alternative first steps of the invention in accordance with two embodiments thereof.

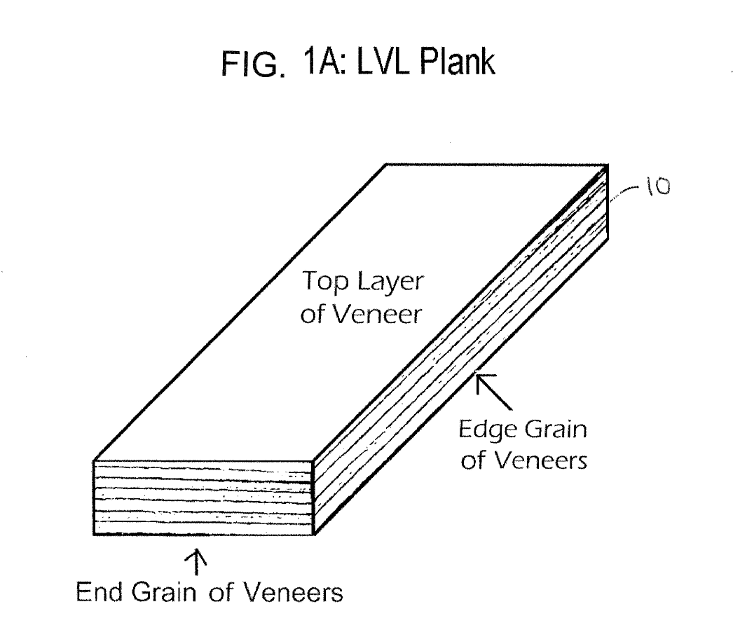

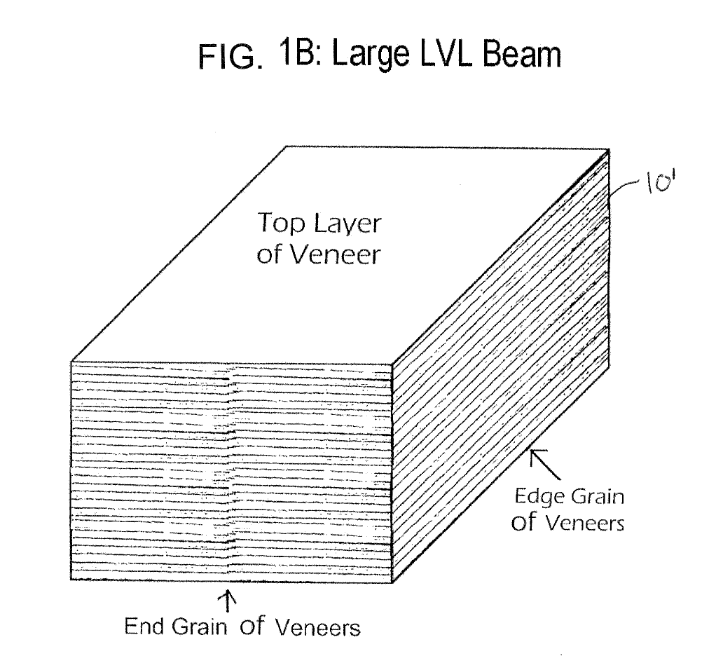

Specifically, FIG. 1A is an isometric view of a conventional, raw so-called laminated veneer lumber (LVL) plank starting material from which the invented laminar building block can be made; and FIG. 1B is an isometric view of a conventional, raw so-called LVL beam starting material from which the invented laminar building block alternatively can be made.

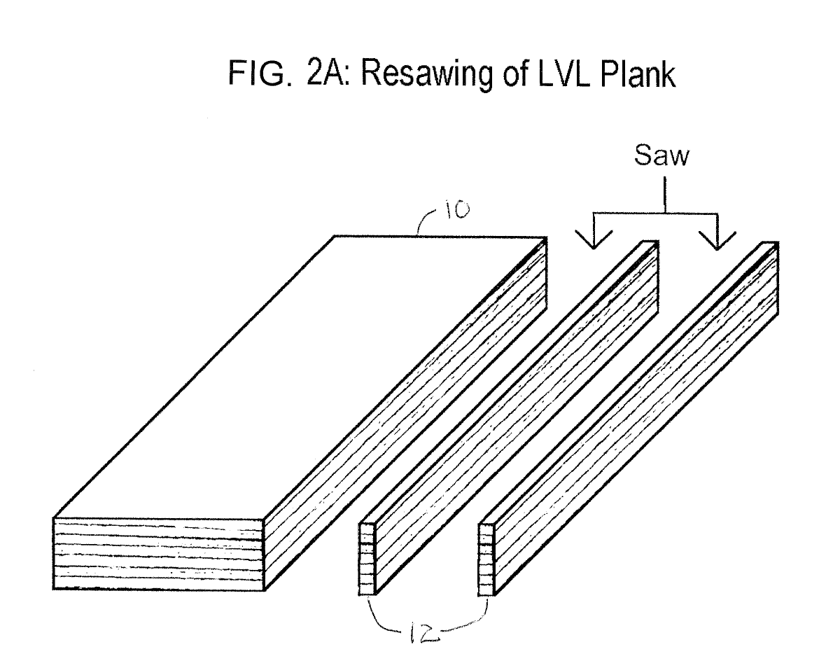

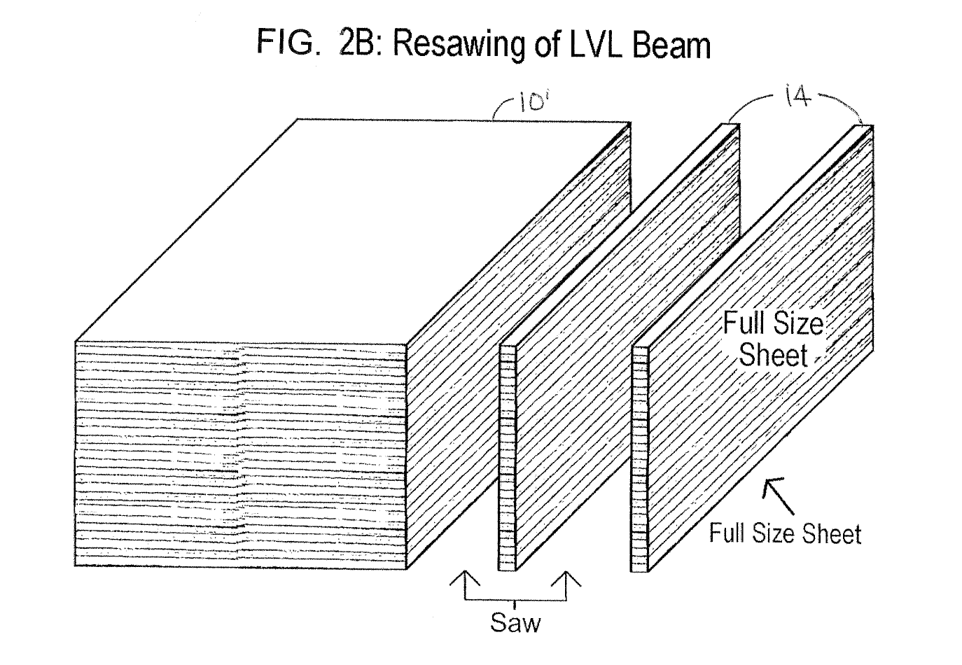

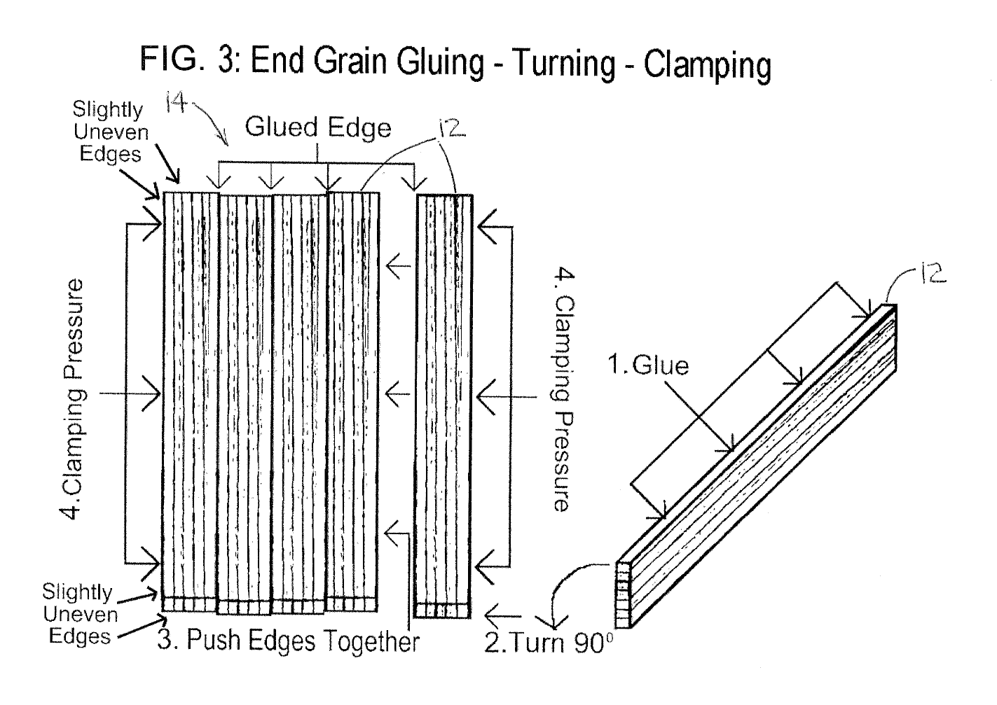

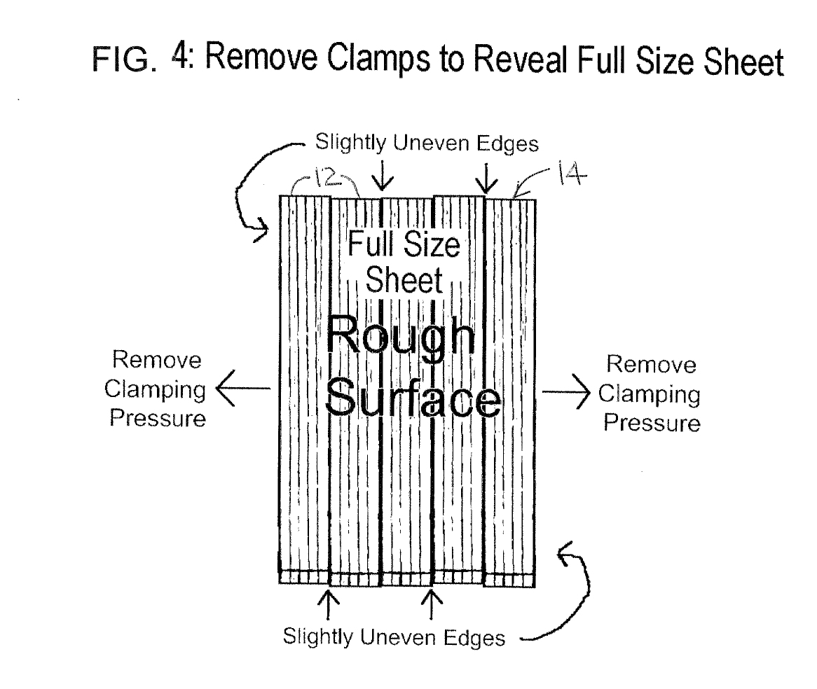

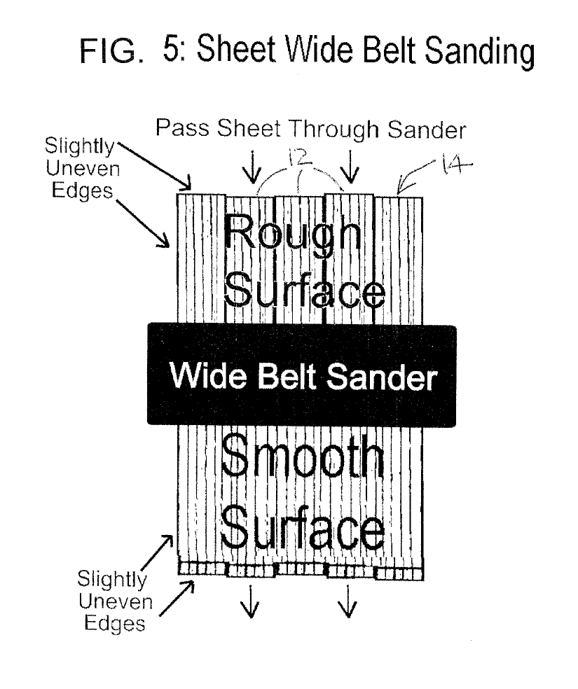

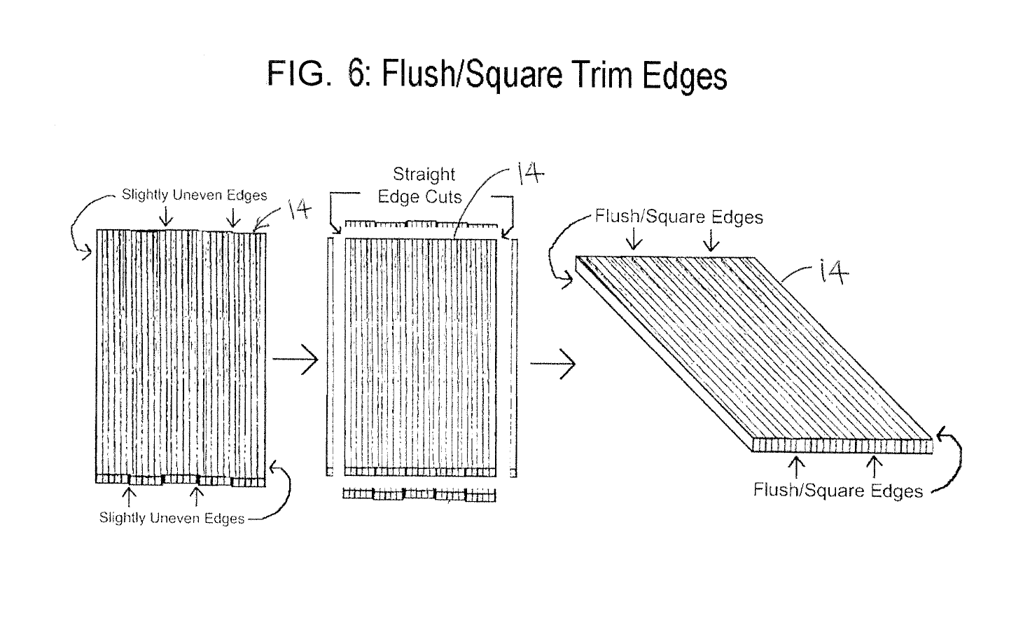

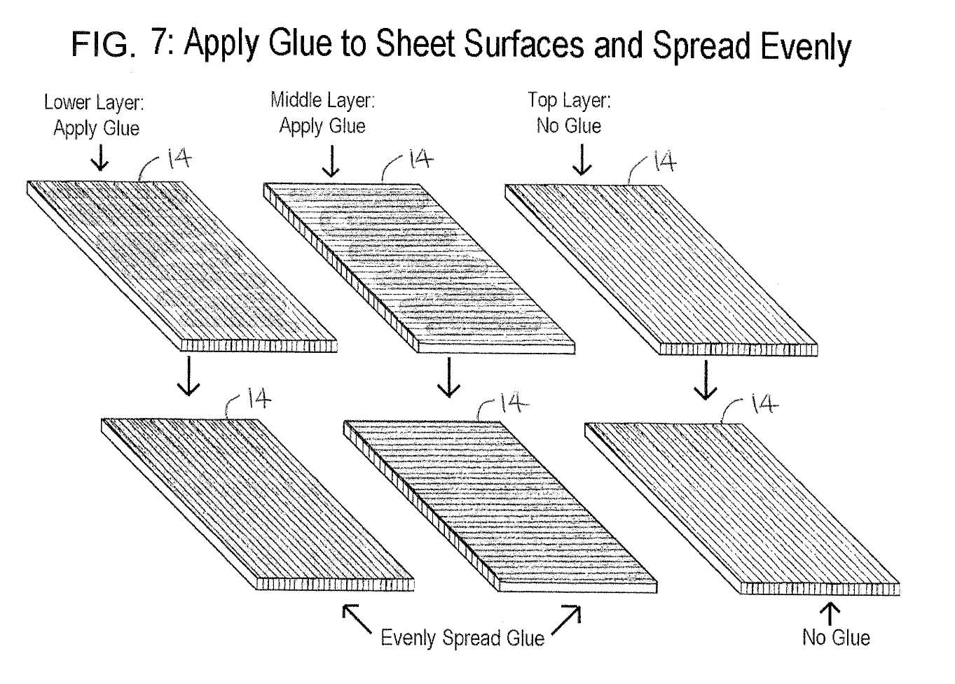

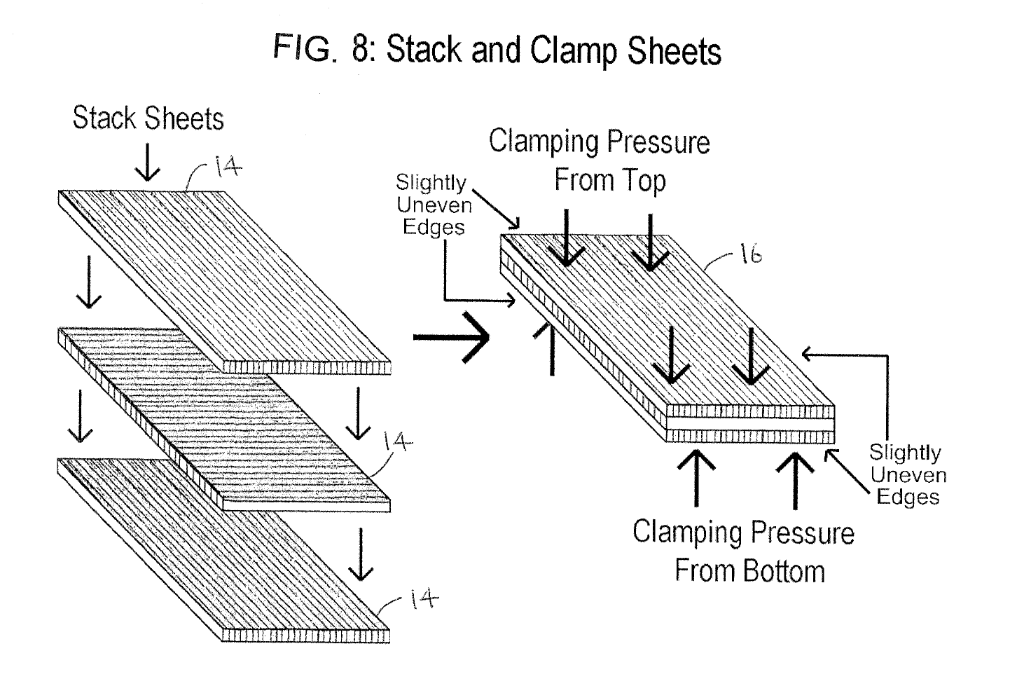

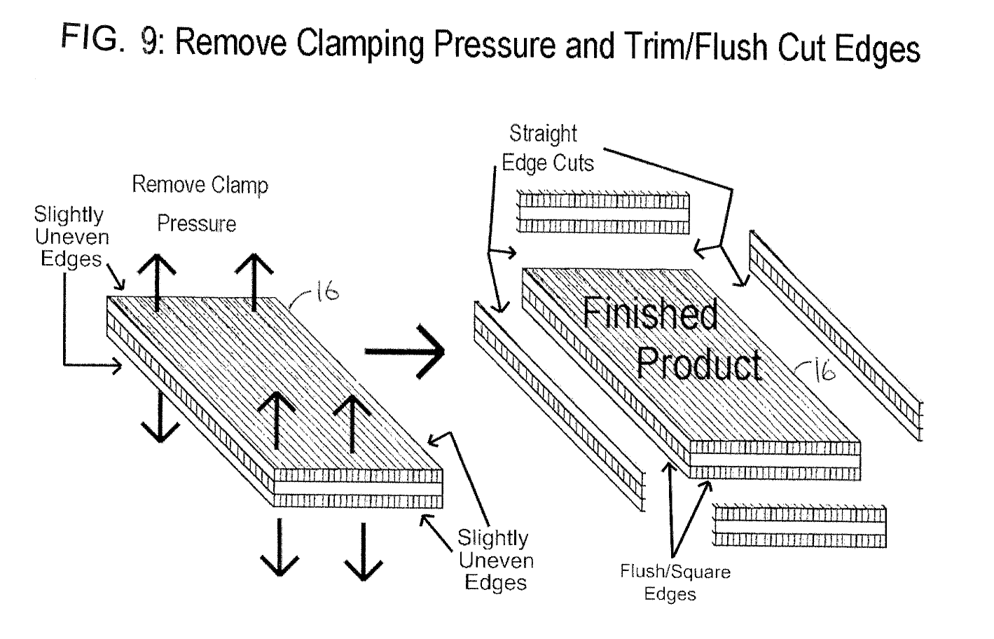

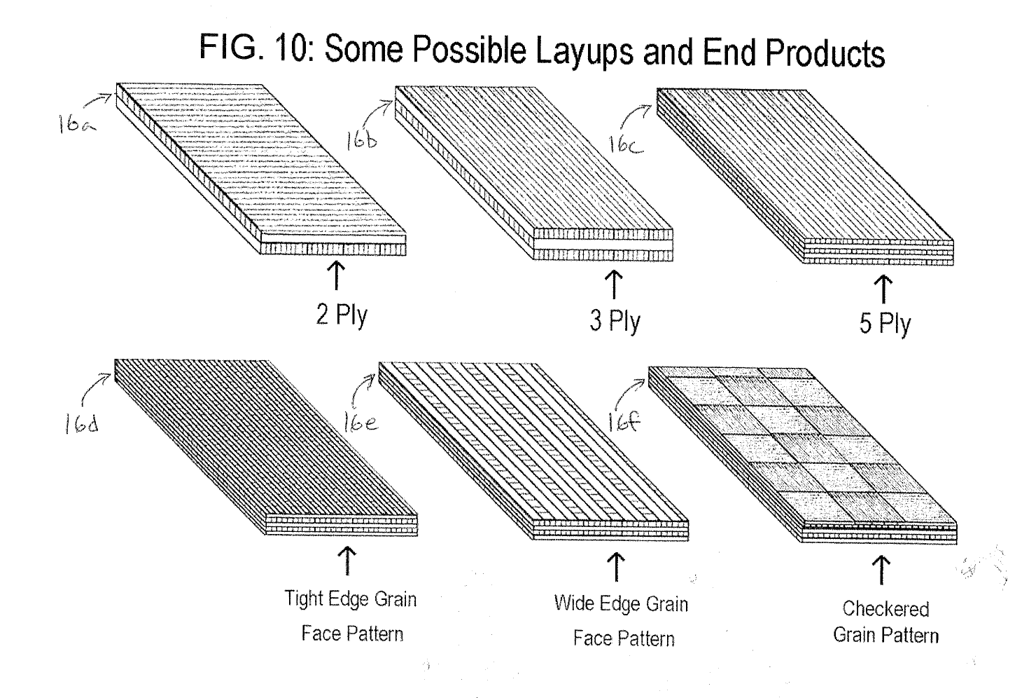

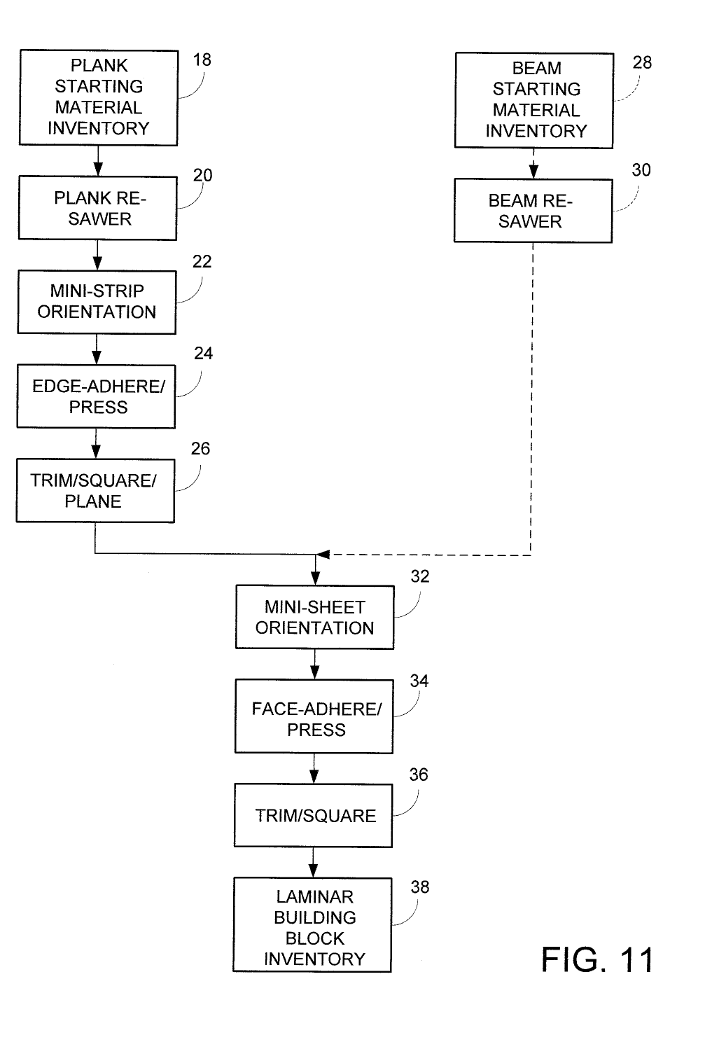

Also specifically, FIG. 2A is an isometric view corresponding to FIG. 1A showing a first step of the invented method by which plural thin so-called mini-plies are formed by re-sawing the LVL plank material of FIG. 1A orthogonally relative to the plane of the plank into plural thin strips; and FIG. 2B is an isometric view corresponding to FIG. 1B showing an alternative first step of the invented method by which plural thin so-called mini-sheets are formed by re-sawing the LVL beam material of FIG. 2A orthogonally relative to the elongate central axis of the beam into plural thin planar sheets.

FIG. 3 is an isometric view of one embodiment of the invention showing plural ones of the planar laminar mini-strips of FIG. 2A are turned 90 degrees, laid side by side, their edges glued, and they are pressed together in a roughly right rectangular and planar array or sheet.

FIG. 4 is an isometric view corresponding with FIG. 3 but with the pressing clamps removed to reveal slightly uneven edges and a slightly rough upper surface of the planar array or sheet.

FIG. 5 is an isometric view of the planar array or sheet of either FIG. 2B or FIG. 4 with a slightly rough upper surface sanded to produce a smooth upper surface.

FIG. 6 is an isometric view of the smoothed planar array or sheet being edge trimmed to produce a desirably right rectangular, smooth, thin laminar sheet.

FIG. 7 is an isometric view of plural ones of the planar arrays or sheets of FIG. 5 with mating interior surfaces glued and the glue spread evenly thereacross.

FIG. 8 is an isometric view of the plural prepared ones of the planar arrays or sheets oriented at desired angles relative one another and pressed into a vertically stacked laminar building block, in accordance with one embodiment of the invention by which alternate layers are rotated transversely, e.g. 90 degrees, relative one another.

FIG. 9 is an isometric view of the pressed and stacked laminar building block of FIG. 8 being edge trimmed to produce a finished, right-rectangular laminar building block useful in hundreds of applications.

FIG. 10 is an array of isometric views of the novel laminar building block featuring plural, vertically stacked and adhered, transversely oriented mini-sheets, in accordance with six different illustrative layup embodiments of the invention that suggest its broad applications and advantages.

FIG. 11 is a system block diagram of a system for manufacturing the invented building block, in accordance with another embodiment of the invention.

### DETAILED DESCRIPTION OF THE PREFERRED EMBODIMENTS

The invented mini-ply laminar building block is similar in appearance to that of the PLYBOO™ and KIRIE™ bamboo- and coconut shell reed- or strand-based sheets discussed above in the Background section. But it is evident that both prior art approaches rely heavily on filler for planar and straight, smooth outer surface finish. This is believed to be due to the use of individual bamboo or coconut shell reeds or strands as the base component of the constructed sheets.

In contrast, the fabrication and layup technique that produces the invented laminar building block or sheet product made therefrom features a simpler and less labor- and filler-intensive process that produces more aesthetic and uniformly wood-product dense laminar building blocks. This is in large part because of the inventive use of a laminar platform, whether it be plural laminar mini-strips made from LVL planks or sheets made from LVL beams (or a suitable alternative such as Weyerhauser's oriented-strand or so-called laminated strand lumber (LSL) or parallel strand lumber (PSL), which can utilize smaller trees but nevertheless produce highly durable planks and beams). Those of skill in the art will appreciate that the laminar platform (e.g. a LVL, LSL, PSL or similar) plank or beam that is used as a starting material may be purchased in the marketplace before the manufacture of the invented laminar building block commences, as described and illustrated herein. Alternatively, yet within the spirit and scope of the invention, the laminar platform (e.g. a LVL, LSL, PSL or similar) plank or beam may be fabricated as a preparatory step in the manufacture of the invented laminar building block.

In brief summary, the invented manufacturing process involves (a) forming plural mini-strips of LVL plank material, (b) turning the strips 90 degrees to flatten them, (c) laying the flattened mini-strips side by side in a rectilinear array, (d) adhering the strips using a standard glue and press technique to form thin laminar sheets or mini-sheets, and finally (e) rotating and stacking plural thus-formed mini-sheets to form a vertical stack or targeted laminar sheet, again by the use of a standard glue and press technique. Alternatively, and more simply, the invented process involves (a′) forming the thin laminar sheets by sawing the same from LVL beam material, skipping unnecessary steps (b)-(d), and then jumping directly to step (e). The resulting planar sheet in either case features a laminar or cross-grain surface look on alternately exposed edges and/or surfaces, as may be seen by brief reference to FIG. 10.

Two or more such planar structures as are produced by steps (a)-(d) or (a′) thus are stacked and adhered to one another preferably (for strength and aesthetic edge appearance) with the grains of adjacent mini-sheets oriented at cross or transverse, e.g. right, angles to one another to produce the a laminar panel of useful width, e.g. ˜1.9 centimeter (1.9 cm) (¾ inch), and of useful area, e.g. ˜122 cm×˜244 cm (4 feet×8 feet). The resulting decorative and durable laminar sheets optionally are squared and edge trimmed, as is conventional with plywood and other wood construction panels.

Each of plural plies is rotated a desired number of degrees from the one below it, in accordance with one embodiment of the invention. Thus a 4-ply layup might have adjacent grains running at 90 degree angles, and an 8-ply layup might have adjacent grains running at 45 degree angles, thereby making the plies' edge appearance more varied and also making the overall product denser, stronger, less prone to sag or warp, and ultimately more durable, all due to the angled orientations of the layers relative one another.

The invented laminar wood product described and illustrated herein is marketed under the SPEKPLY™ trademark owned by the inventor of the present invention. World-wide rights are reserved.

### DEFINITIONS

By micro-ply or micro-strip as used interchangeably herein is meant a ply or strip of material that is an extremely small fraction of the size in at least two dimensions of a targeted laminar sheet of which it is a component part. By mini-ply or mini-strip as used interchangeably herein is meant a ply containing plural, e.g. two or more, laminar micro-plies or micro-strips laid side by side and adhered in a planar configuration, wherein the ply is a small fraction of the size in at least two dimensions of the targeted laminar sheet of which it is a component part. By mini-sheet as used herein is meant a sheet containing plural, e.g. two or more, turned and horizontally (i.e. side-by-side) stacked and adhered ones of such mini-plies or mini-strips, wherein the mini-sheet is a substantial fraction of, e.g. substantially equal to, the size of the targeted laminar sheet of which it is a component part. By targeted laminar sheet as used herein is meant a sheet of vertically stacked and adhered plurality, e.g. two or more, mini-sheets. Typically, a micro-strip or micro-ply might include a single laminar element; a mini-ply or mini-strip might include approximately 3-8 laminar elements; a mini-sheet might include approximately 30-80 laminar elements or approximately 3-8 mini-strips; and a targeted laminar sheet might include approximately 2-8 mini-sheets. Within the spirit and scope of the invention, other numbers and ranges of numbers are contemplated as being within the spirit and scope of the invention. Those of skill will appreciate that ply and veneer may be used interchangeably to refer to a single thin planar sheet of material. Finally, those of skill in the art will appreciate that the targeted laminar sheet also may be referred to herein as the invented building block.

FIGS. 1A and 1B, and FIGS. 2A and 2B illustrate alternative first steps of the invention in accordance with two embodiments thereof.

FIG. 1A is an isometric view of a conventional, raw so-called laminated veneer lumber (LVL) plank or starting material 10 from which the invented laminar building block can be made. Starting material 10 may be seen to include plural, vertically stacked, thin, planar laminar sheets characterized by pairwise-adjoined, e.g. adhered, interior surfaces. Typically, such starting material 10 is conFIG.d as a right-rectangular parallelepiped and features a top layer of veneer or laminate, and edge grain of veneers or laminates, and an end grain of veneers or laminates, as indicated.

FIG. 1B is an isometric view of a conventional, raw so-called LVL beam or alternative starting material 10′ from which the invented laminar building block alternatively can be made. Starting material 10′ may be seen to include plural, vertically stacked, thin, planar laminar sheets (laminates) characterized by pair-wise adjoined, e.g. adhered, interior surfaces. Typically, such starting material 10 is conFIG.d as a right-rectangular parallelepiped and features a top layer of veneer or laminate, and edge grain of veneers or laminates, and an end grain of veneers or laminates, as indicated.

Those of skill will appreciate that the main difference between starting material 10′ and starting material 10 is dimensional. In other words, it may be seen that starting material 10′ is thicker and preferably also wider than is starting material 10. It also may be seen that starting material 10′ typically has more laminates than does starting material 10. Starting material 10 typically may have from 2-8 laminates or veneers while starting material 10 typically may have from 2-50 or more laminates or veneers. In both cases, the grains of the laminates or veneers typically extend in parallel, as indicated. Preferably, starting material 10′ may be twice as wide as starting material 10, or more. Those of skill in the art will appreciate that starting material 10′ may be made by stacking and adhering two or more planks of starting material 10, effectively turning one or more laminar, typically aligned-grain planks into a single, typically aligned-grain beam.

FIG. 2A is an isometric view corresponding to FIG. 1A showing a first step of the invented method by which plural thin so-called mini-strips or mini-plies 12 of laminar material are formed by re-sawing the LVL plank material 10 of FIG. 1A. Those of skill in the art will appreciate that mini-strips 12 may be formed from starting material 10 by any suitable method, including without limitation re-sawing using a saw (e.g. a table saw, band saw, or other suitable saw), a laser (e.g. a CO₂ laser equipped with a air-assisted cooling and/or venting technology to avoid heat damage to fragile wood fibers), a high-pressure water jet (equipped with a heater/dryer), or other means contemplated as being within the spirit and scope of the invention. Those of skill in the art also will appreciate that such re-sawing typically may be done in such manner that the mini-strips are regular in shape and dimension, as shown, thus reducing set-up costs, labor, etc. Preferably, mini-strips 12 each are also rendered in the shape of a right-angled parallelepiped, as shown, and the width of each micro-strip therein is a less than ˜6.3 millimeters (6.3 mm) (¼ inch). As many like mini-strips 12 may be cut from starting material 10 as desired or as needed.

FIG. 2B is an isometric view corresponding to FIG. 1B showing an alternative first step of the invented method by which plural thin so-called mini-sheets 14 are formed by re-sawing the alternative LVL beam starting material 10′ of FIG. 2A into plural thin, planar, “full size” sheets of laminated material. Those of skill in the art will appreciate that mini-sheets 14 may be formed from alternative starting material 10′ by any suitable method, including without limitation re-sawing using a saw (e.g. a table saw, band saw, or other suitable saw), a laser, a high-pressure water jet, or other means contemplated as being within the spirit and scope of the invention. Those of skill in the art also will appreciate that such re-sawing typically may be done in such manner that the mini-sheets are regular in shape and dimension, as shown, thus reducing set-up costs, labor, etc. Preferably, mini-sheets 14 each are rendered in the shape of a right-angled parallelepiped, as shown, and the width of each micro-strip therein is less than ˜6.3 millimeters (6.3 mm) (¼ inch). As many like mini-sheets 14 may be cut from starting material 10′ as desired or as needed to produce a dimensionally desirable laminar building block 16 (refer briefly to FIG. 10).

Importantly, mini-strips 12 and mini-sheets 14 are formed in accordance with one embodiment of the invention in such manner that the re-sawing is aligned with the edge grain of the veneers or laminates. As will be seen, this re-sawing orientation relative to the grain of either starting material produces a remarkably durable and aesthetically pleasing novel laminar building block. It is contemplated that, within the spirit and scope of the invention, the re-sawing alternatively may be aligned with the end grain of the veneers or laminates. It is also contemplated that, within the spirit and scope of the invention, the re-sawing alternatively may be aligned with neither the edge nor the end grain of the veneers or laminates but may instead be aligned at any desired angle thereto.

Those of skill in the art will appreciate that, by use of mini-sheets 14 made in accordance with FIGS. 1B and 2B from alternative starting material 10′, the next-described steps by reference to FIGS. 3 and 4 are obviated. Thus, a mini-sheet 14 made from LVL beam material 10′ instead of LVL plank material 10 in accordance with the invention proceeds according to the next steps described below by reference to FIGS. 5-9.

Thus, the steps described immediately below by reference to FIGS. 3 and 4 are required only for mini-sheets 14 produced from LVL plank starting material 10.

FIG. 3 is an isometric view of one embodiment of the invention showing plural ones of the planar laminar mini-strips 12 of FIG. 2A are turned 90 degrees from their vertical orientation shown in FIG. 2A, are laid horizontally in a side-by-side arrangement, their adjacent interior edges are glued, and they are pressed together under a desired clamping pressure into a substantially right rectangular and planar array or mini-sheet 14. Those of skill in the art will appreciate that the ordered steps called out in FIG. 3 include 1) gluing an interior edge of each mini-strip 12, 2) turning each mini-strip 12 by 90 degrees (i.e. laying them flat with their thin longer interior edges abutted), 3) pushing together the mating interior (glued) edges of plural ones of such mini-strips 12, and 4) applying clamping pressure from either side of the generally right-rectangular array of mini-strips 12 to produce a mini-sheet 14.

Those of skill will appreciate that the steps outlined above for the manufacture of mini-sheets 14 may be performed manually. Those of skill also will appreciate that one or more of the steps outlined above alternatively or additionally may be semi-automated or fully automated by the use of conveyor belts, re-sawers, rollers/turners, glue dispensers/spreaders, presses, guides, platens, etc., all under at least the partial control of a programmed computer processor executing instructions stored in a memory. Such semi- and fully-automated systems conventionally are referred to as computer numeric control (CNC) machines that are specially programmed to perform precise and repeatable process steps of an automatic fabrication and/or assembly, i.e. manufacturing, process.

Those of skill in the art will appreciate that generally right-rectangular mini-sheet 14 undesirably may have slightly uneven edges, as illustrated. This may be due to imprecise re-sawing, placement, or handling. It may also be due to the slightest movement of the mini-strips during the application of clamping pressure. It may also be due to other normal manufacturing tolerances. Whatever the source of uneven edges, it is desirable to produce mini-sheets 14 characterized by right-rectangular shapes and as even as possible edges, for both functional and aesthetic reasons.

FIG. 4 is an isometric view corresponding with FIG. 3 but with the pressing clamps removed to reveal slightly uneven edges and a slightly rough upper surface of the planar array of mini-strips 12, i.e. mini-sheet 14. Those of skill in the art will appreciate that a rough upper surface may result from uneven kerfing of the cut surfaces of mini-strips 12 during the re-sawing step, slightly differential thicknesses among mini-strips 12, slight out-of-plane movement thereamong during the clamping pressure process, or even a bur or other out-of-plane anomaly on the nominally planar support surface on which mini-strips 12 are placed. Whatever the source of the rough upper surface, it is desirable to produce mini-sheets 14 characterized by right-rectangular shapes having smooth planar surfaces.

The process steps described below by reference to FIGS. 5-9 are performed, in accordance with one embodiment of the invention, regardless whether starting material 10 or alternative starting material 10′ was used to produce one or more mini-sheets 14.

FIG. 5 is an isometric view of the planar array or sheet of either FIG. 2B or FIG. 4 with a slightly rough upper surface planed or sanded to produce a smooth upper surface. As illustrated, a mini-sheet 14 having a rough upper surface is passed through a wide belt sander or other suitable apparatus to produce a smooth upper surface 14a. Those of skill will appreciate that alternative means or techniques may be used to produce mini-sheets 14 characterized by smooth upper surfaces.

FIG. 6 is an isometric view in three (left-to-right) phases of the smoothed planar array or mini-sheet 14 being edge-trimmed to produce a desirably right rectangular, smooth, thin laminar mini-sheet. Those of skill in the art will appreciate that the edges may be straight cut at a right angle on either end and at either side to produce a smooth, planar, substantially right-rectangular mini-sheet 14 characterized now also by straight/flush/square edges and right-angled corners all around.

Those of skill will appreciate that such surface-smoothing, squaring and edge-trimming steps may be performed manually, semi-automatically, or fully automatically, as described above. Those of skill also will appreciate that, within the spirit and scope of the invention, the squaring and edge-trimming steps may utilize any suitable sawing or edging apparatus such as a trim saw, laser, or the like, also as described above.

FIG. 7 is an isometric view of plural ones of the planar arrays or mini-sheets 14 of FIG. 5 in a first phase (upper row of illustrations) with glue applied to interior surfaces that are to be adjoined and in a second phase (lower row of illustrations) with the glue spread evenly thereacross. Those of skill in the art will appreciate that the top layer of mini-sheet 14 requires and thus gets no glue, whereas the lower layer and middle layer require and get glue. Those of skill in the art will appreciate that the glue may be applied and spread using any suitable manual or semi-automatic or fully automatic tools or equipment, including CNC equipment as described above. Those of skill will appreciate that these gluing and glue-spreading steps are preparatory to producing a finished product referred to herein as the invented vertically stacked laminar building block 16 shown in FIGS. 9 and 10.

Those of skill in the art will appreciate that the three mini-sheets 14 shown in FIG. 7 are oriented with their edge and end grains transverse, e.g. 90 degrees, to one another. This is a desirable way to ensure a quality, durable, aesthetic product that has excellent sag and warp-resistance. Applicant does not intend to be constrained by his theory of his invention's operation. Nevertheless, applicant believes that the transverse and preferably 90 degree orientation of adjacent mini-sheets 14 relative to one another within laminar building block 16 greatly improve latter's planarity, sag-resistance, and warp-resistance because of the randomized placement of any voids or lower-density regions within or between micro-strips or mini-strips and any filler material therein or therearound.

Applicant notes also that 90 degrees is but one choice among many of transverse orientation adjacent mini-sheets 16, in accordance with embodiments of the invention. Indeed, the edge and end grains of each stacked layer may be oriented relative to the one beneath it at an angle of 180/n degrees, wherein n is the number of layers to be vertically stacked. It is believed that this may further randomize placement-based and orientation-based weaknesses that may characterize one or more mini-sheets 14, thereby producing even stronger end-product 16 made in accordance with the invention.

FIG. 8 is an isometric view of the plural prepared ones of mini-sheets 14 oriented at desired angles relative one another and pressed into a vertically stacked laminar building block 16, in accordance with one embodiment of the invention by which alternate layers are rotated 90 degrees relative to one another. Those of skill in the art will appreciate that on the left side of FIG. 8 three mini-sheets 14 having transverse, e.g. 90 degree angled, grain orientations relative to one another are shown one above the other in a vertical stack. On the right side of FIG. 8, the three are brought together in close orientational alignment and their glued edges are joined by the exertion of a clamping pressure from above and below. Again, those of skill in the art will appreciate that there may remain slightly uneven edges after the clamping step. These may result from slight mis-alignments of the mini-sheets 14 relative to one another.

FIG. 9 is an isometric view of the pressed and stacked laminar building block 16 of FIG. 8 being edge trimmed to produce a finished, right-angled parallepipedal laminar building block useful in hundreds of applications. Those of skill in the art will appreciate that this final edge-trimming step is similar to that shown in FIG. 6 and described above, but that the trimming step is now applied to building block 16 instead of to individual mini-sheets 14.

Those of skill in the art will appreciate that the alignment, stacking, clamping, and trimming steps described above by reference to FIGS. 8 and 9 may be performed manually or may be semi-automated or fully automated by the use of appropriate clamping and trimming apparatus under CNC or similar automation techniques. Indeed, any suitable manual or automated process for these manufacturing steps is contemplated as being within the spirit and scope of the invention.

FIG. 10 is an array of isometric views of the novel laminar building block featuring plural, vertically stacked and adhered, transversely oriented mini-sheets, in accordance with six different illustrative layup embodiments of the invention that suggest its broad applications and advantages. Specifically, building block 16a features a 2-ply stack, building block 16b features a 3-ply stack, building block 16c features a 5-ply stack, building block 16d features a 5-ply stack with a tight edge grain face pattern or veneer, building block 16e features a 4-ply stack with a wide edge grain face pattern or veneer, and building block 16f features a 4-ply stack with a checkered grain face pattern or veneer. Those of skill in the art will appreciate that each building block in FIG. 10 features two or more plies in transversely orientations to one another, wherein each ply is a mini-sheet 14 as described and illustrated herein.

Persons skilled in the art will appreciate that the regular vertical lining (representing the adhered seams between adjacent micro-strips (an attractive artifact of the LVL starting material's manufacture), as well as the adhered seams between adjacent mini-strips (an attractive artifact of the end product's manufacture described and illustrated herein)) of alternate cross-grain edges add an aesthetic beauty to the invented laminar building block. Indeed, in accordance with one embodiment of the invention, the LVL starting material includes substantially evenly spaced edge seams represented by substantially uniformly wide micro-strips. This produces a pleasing and ordered array of uniformly lined cross-cut and exposed plies (end grains) in the finished edges of the invented building block 16. Preferably, the uniformity of the average width of the plural micro-strips is more than approximately 60 percent, more preferably more than approximately 80 percent, even more preferably more than approximately 90 percent, and most preferably more than approximately 95 percent.

Moreover, the very regular shapes and dimensions of the mini-strips 12 or mini-sheets 14 produced by cross-cutting or re-sawing an already laminated wood starting material ensures better fit and tighter fill of the micro-strips arrayed in each of the plural mini-sheets that make up the laminar building block 16. This use of LVL, LSL, PSL or the like as the preferred starting material reduces labor and filler requirements, increases density, improves yield, and eliminates voids that otherwise might compromise the durability and finished quality of a laminar building block. And it looks just as good as products made at higher cost with the labor intensive placement of individual thin strands or reeds.

Those of skill in the art will appreciate that nearly limitless alternative layups of the invented building block 16 are contemplated as being within the spirit and scope of the invention. Such can be realized by varying the starting material, by varying the thickness and number of plies, and/or by adding interesting face patterns or veneers that also feature the exposed micro-strip and mini-strip or mini-sheet function and aesthetic appeal.

FIG. 11 is a system block and flow diagram of a system and method for manufacturing the invented building block, in accordance with another embodiment of the invention. Those of skill in the art will appreciate that the arrows indicate the general direction of material flow between blocks. The system includes a plank starting material inventory station 18, a plank re-sawer station 20, a mini-strip orientation station 22 (also referred to herein as a turning station), an edge-adhere/press station 24, and a trim/square/plane station 26, all of which collectively produce a mini-sheet 14 from an LVL plank 10, as described and illustrated above. The system alternatively (as indicated by dashed lines) includes a beam starting material inventory station 28 and a beam re-sawer station 30, which collectively produce a mini-sheet 14 from an LVL beam 10′. In either case, the system further includes a mini-sheet orientation station 32, a face-adhere/press station 34 (also referred to herein as a gluing/spreading station), a trim/square station 36, and a laminar building block inventory station 38.

Thus raw material staged at station 18 or 28 is processed into finished product stored at station 38.

Those of skill in the art will appreciate that one or more illustrated manufacturing steps and stations may be omitted, altered, and/or combined into a single step or station. For example, the mini-strip orientation step may be omitted entirely if the plank re-sawer station 20 is appropriately oriented to produce horizontal cuts and horizontally oriented mini-strips. And/or plank re-sawer station 20 and edge-adhere/press station 24 may be combined into one continuous at least semi-automated operation. Similarly, face-adhere/press station 34 and trim/square station 36 may be combined into one continuous at least semi-automated operation. Moreover, additional processing stations may be added, within the spirit and scope of the invention, such as a catalyzing, curing, staining, and/or finishing station. Indeed, laminar building block 16 may be treated with a filler to smooth any surface imperfections that survive the sanding operation. Typically, the filler material is a so-called ‘stainable’ wood filler obtained from any suitable source. Alternatively or additionally, laminar building block 16 may be impregnated with a fiber-hardening agent that creates even more durability for an even greater variety of end uses. Those of skill also will appreciate that the system and method of manufacturing the invented building block may be manual or semi- or fully-automated, as by CNC described above but not shown in FIG. 11 for the sake of clarity.

Uses for the invented laminar building block 16 are nearly limitless, since its configuration, size, and appearance lend it to at least as many applications as veneered plywood. Such uses include using the building block in the fabrication and construction of tables, counter-tops, bookcases, cabinets, wall and floor coverings, room dividers, etc. Those of skill in the art will appreciate that the sheet-like building block 16 may be fabricated in any desired thickness, width and length, and can be cut to a desired smaller area and shape, the cut pieces of which can then be rabbeted, mitered, nailed, screwed, glued, hot-glued, stapled, doweled and/or otherwise joined and finished to produce furniture, flooring, decks, dividers, tables, chairs, etc. virtually without limitation. The advantages of the invented laminar building block 16 include the fact that it is more regular, dense, sag-resistant, warp-resistant, and decorative than conventionally available wood-based building blocks such as composites, plywood, or even decoratively veneered plywood (which typically includes a laminar core of fir or the like and a higher quality and density hardwood face or upper surface of ash or the like). Moreover, it is more regular and smooth than, more dense than, more durable than, and less labor-intensive than PLYBOO™ or KIRIE™, and thus not only higher quality but also less expensive than these two relatively new approaches to the market.

It will be understood that the present invention is not limited to the method or detail of laminar building block construction, fabrication, material, application or use described and illustrated herein. Indeed, any suitable variation of fabrication, use, or application is contemplated as an alternative embodiment, and thus is within the spirit and scope, of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Finally, those of skill in the art will appreciate that the invented manufacturing system and method described and illustrated herein may be implemented by software, firmware or hardware, or any suitable combination thereof. Preferably, the system and method for manufacture are implemented in a combination of the three, in combination with manual processing, for purposes of low cost and flexibility. Thus, those of skill in the art will appreciate that embodiments of the software-implemented or software-assisted or -automated system elements and method steps may be implemented by a computer or microprocessor process in which instructions are executed, the instructions being stored for execution on a computer-readable medium and being executed by any suitable instruction processor.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

I claim:

1. A laminar building block comprising:
plural laminar sheets in a stack of a defined thickness,
wherein adjacent ones of the plural stacked laminar sheets are adhered to one another, and
wherein each sheet includes plural aligned uniformly dimensioned micro-strips adjacent ones of which are adhered to each other,
the laminar building block being of a generally right parallelepiped shape having planar dimensions that are substantially greater than the defined thickness of the plural stacked laminar sheets.

2. The laminar building block of claim 1, wherein alternate ones of the plural stacked laminar sheets are oriented within the stack at a rotational angle relative to one another.

3. The laminar building block of claim 2, wherein the rotational angle is approximately ninety degrees.

4. The laminar building block of claim 1, wherein the uniformity of an average width dimension of each of the uniformly dimensioned micro-strips is greater than approximately 60%.

5. The laminar building block of claim 4, wherein the uniformity of the average width dimension of the plural micro-strips is greater than approximately 80%.

6. The laminar building block of claim 5, wherein the uniformity of the average width dimension of the plural micro-strips is greater than approximately 90%.

7. The laminar building block of claim 6, wherein the uniformity of the average width dimension of the plural micro-strips is greater than approximately 95%.

8. The laminar building block of claim 1, wherein the micro-strips are each made from a material including wood fiber.

9. The laminar building block of claim 1 manufactured by a process that comprises:
forming plural thin sheet-like mini-strips each including a plurality of the micro-strips;
abutting adjacent edges of adjacent ones of the mini-strips to form a thin sheet of abutted micro-strips; and
adhering the abutted edges with an adhesive.

10. The laminar building block of claim 9, wherein the micro-strips are each made from a material including wood fibers, and wherein the manufacturing process further comprises:
one or more of squaring, filling, sanding, staining, sealing, and applying a finish coat to the laminar building block.

11. The laminar building block of claim 1 manufactured by a process that comprises:
forming plural thin sheets each including a plurality of the micro-strips by cross-cutting, lasing, or water-jetting each of the plural thin sheets from an end of a laminar beam.

12. The laminar building block of claim 11, wherein the micro-strips are each made from a material including wood fibers, and wherein the manufacturing process further comprises:
one or more of squaring, filling, sanding, staining, sealing, and applying a finishing coat to the laminar building block.

13. A laminar sheet comprising:
plural aligned mini-strips adjacent ones of which are adhered to one another along abutted edges thereof,
wherein each mini-strip includes plural aligned uniformly dimensioned micro-strips adjacent ones of which are adhered to one another along abutted edges thereof, the plural aligned and adhered mini-strips forming a unitary planar sheet.

14. The laminar sheet of claim 13, wherein the uniformity of an average width dimension of the plural micro-strips is greater than approximately 60%.

15. The laminar sheet of claim 14, wherein the uniformity of the average width dimension of the plural micro-strips is greater than approximately 80%.

16. The laminar sheet of claim 15, wherein the uniformity of the average width dimension of the plural micro-strips is greater than approximately 90%.

17. The laminar sheet of claim 16, wherein the uniformity of the average width dimension of the plural micro-strips is greater than approximately 95%.

18. A method for manufacturing a laminar building block, the method comprising:
forming a plurality of sheet-like laminates by laying side-by-side a plurality of thin sheet-like mini-strips, each mini-strip including plural micro-strips;
adhering together adjacent edges of the mini-strips;
stacking the plurality of sheet-like laminates while alternately rotationally orientating the grains thereof relative to one another; and
adhering together adjacent ones of the stacked and alternately rotationally oriented plurality of sheet-like laminates.

19. The method of claim 18, wherein each mini-strip is formed by cross-cutting a laminated veneer lumber plank.

20. The method of claim 18, wherein the plural micro-strips each are made from a material including a wood fiber, which method further comprises:
one or more of squaring, filling, sanding, staining, sealing, and applying a finishing coat to the laminar building block.

21. A method for manufacturing a laminar building block, the method comprising:
forming a plurality of sheet-like laminates, each laminate including plural micro-strips adjacent ones of which are adhered to one another along abutted edges thereof;
stacking the plurality of sheet-like laminates while alternately rotationally orientating the grains thereof relative to one another; and
adhering together adjacent ones of the stacked and alternately rotationally oriented plurality of sheet-like laminates.

22. The method of claim 16, wherein each sheet is formed by cross-cutting a laminated veneer lumber beam.

23. The method of claim 16, wherein the plural micro-strips each are made from a material including a wood fiber, which method further comprises:
one or more of squaring, filling, sanding, staining, sealing, and applying a finishing coat to the laminar building block.
